(19) United States
(12) Patent Application Publication
(10) Pub. No.: US 2024/0310548 A1
(43) Pub. Date: Sep. 19, 2024

(54) Deep Sonic Image Velocity Scan

(71) Applicant: Halliburton Energy Services, Inc., Houston, TX (US)

(72) Inventors: Mark Willis, Houston, TX (US); Oscar Barrios Lopez, Houston, TX (US)

(73) Assignee: Halliburton Energy Services, Inc., Houston, TX (US)

(21) Appl. No.: 18/598,890

(22) Filed: Mar. 7, 2024

Related U.S. Application Data
(60) Provisional application No. 63/452,084, filed on Mar. 14, 2023.

(51) Int. Cl. G01V 1/50; E21B 49/00

(52) U.S. Cl. CPC G01V 1/50; E21B 49/00; G01V 2210/6222

(57) ABSTRACT

Systems and methods for obtaining downhole images through velocity analysis may be provided. For example, systems and methods may disposing a borehole sonic logging tool into a borehole disposed in a formation, wherein the borehole sonic logging tool comprises: a transmitter configured to transmit sonic energy comprising at least one or more waveforms into a formation; and one or more receivers configured to record a sonic wave field comprising at least one or more reflected waveforms and one or more direct and/or guided waveforms. In addition, systems and methods may select a group of traces from a receiver; select a set of trial velocities from at least a sonic profile; compute a coherence value between at least two or more traces from the shifted group of traces; record the coherence value for the shifted group of traces at its initial trial velocity and depth; and determine reflections.

### BACKGROUND

In order to obtain hydrocarbons such as oil and gas, boreholes are drilled through hydrocarbon-bearing subsurface formations. Logging tests are subsequently made to determine the properties of formations surrounding the borehole. In wireline logging, a drilling apparatus that forms the borehole is removed so that testing equipment can be lowered into the borehole for testing. In measurement-while-drilling techniques, the testing equipment is conveyed down the borehole along with the drilling equipment. These tests may include resistivity testing equipment, gamma radiation testing equipment, seismic imaging equipment, etc. In examples, seismic imaging using borehole acoustic measurements may obtain an image of the formation structural changes, which may be referred to as a reflector.

Traditionally, a transmitter emits acoustic signals into the fluid-filled borehole. In examples, some of the signals may traverse through the formation and are reflected back to the borehole by a reflector in the formation. The reflected signals may travel back to the borehole and are captured by the receivers in the borehole. Reflected signals captured by receivers may be represented as full waveform sonic data, which may be utilized to derive the formation velocity (or slowness) parameters.

Currently, the full waveform sonic data may be utilized to create a velocity analysis of the formation boundaries and fractures. However, not all reflected waves travel through enough reflection events to capture desired boundaries and fractures. For example, acoustic signals emitted from the fluid-filled borehole must travel through the totality of a formation comprising boundaries and fractures. However, the formation is a composite of at least reflection events, boundaries, and fractures, and reflection events may prohibit acoustic signals from reaching the totality of a formation. In examples, it may be difficult to determine if an acoustic signal emitted from the fluid-filled borehole traveled through the totality of the formation. As such, it may be a challenge to determine if the full sonic waveforms contain the needed reflection events to perform imaging processing. In effect, without determining if the full sonic waveforms contain the needed reflection events image processing techniques may yield an inaccurate velocity analysis.

### BRIEF DESCRIPTION OF THE DRAWINGS

These drawings illustrate certain aspects of some examples of the present disclosure and should not be used to limit or define the disclosure.

FIG. 1 illustrate an example of a borehole sonic logging system;

FIG. 2 illustrates an example of a sonic logging tool;

FIG. 3 illustrates an example of reflected wave imaging with sonic logging tool;

FIG. 4A illustrates an example of sonic logging tool;

FIG. 4B illustrates an example of a ring of sonic logging tool;

FIG. 5 is a workflow for a circular velocity scan;

FIG. 6 illustrates input traces acquired by sonic logging tool;

FIG. 7 illustrates a circularly shifted trace;

FIG. 8 illustrates the coherence velocity;

FIG. 9 shows a simple model of a vertical well;

FIG. 10 illustrates a synthetic sonic waveform gathered from a single ring;

FIG. 11 illustrates a circular velocity scan input record of synthetic data;

FIG. 12 illustrates the circular velocity scan;

FIG. 13 illustrates workflow 1300 for a full velocity scan;

FIG. 14 illustrates an example image formed utilizing a full slant stack analysis; and

FIG. 15 illustrates another example of an image utilizing field data.

### DETAILED DESCRIPTION

This disclosure may generally relate to systems and methods for characterizing the full waveform sonic data to discern if there is the needed reflection data to create a velocity analysis of the formation away from the borehole. Generally, conventional sonic log velocity (or slowness) analyses are performed on direct waves of the reflected wave. These direct waves are considered noise for reflection imaging. Conventional methods assume a transmission of the sonic waves across the array of receivers on an acoustic logging tool. As discussed below, the geometry of the analysis is changed to be for only reflected waves. The direct waves are filtered out of the input data, and the reflections of features may be analyzed in the formation away from the borehole. In addition, the velocities (or slowness) derived using the systems and methods described below are apparent velocities, not the actual formation velocity (or slowness), as the reflected waves are being reflected from features not near the borehole. These apparent velocities (or slowness) may also appear faster than the actual formation velocity (slowness).

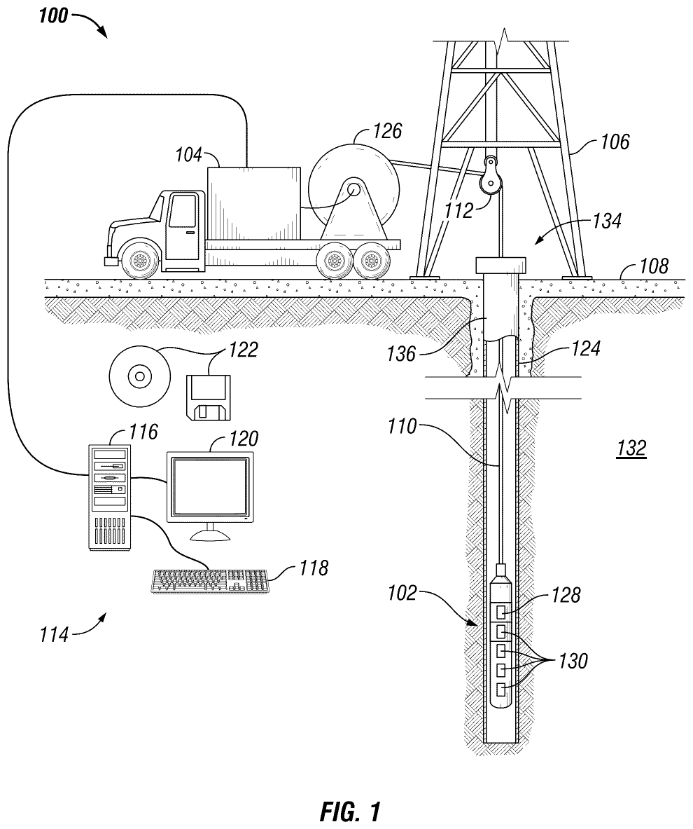

FIG. 1 illustrates a cross-sectional view of a borehole sonic logging system 100. As illustrated, borehole sonic logging system 100 may comprise a sonic logging tool 102 attached to a vehicle 104. In examples, it should be noted that sonic logging tool 102 may not be attached to a vehicle 104. Sonic logging tool 102 may be supported by rig 106 at surface 108. Sonic logging tool 102 may be tethered to vehicle 104 through conveyance 110. Conveyance 110 may be disposed around one or more sheave wheels 112 to vehicle 104. Conveyance 110 may include any suitable means for providing mechanical conveyance for sonic logging tool 102, including, but not limited to, wireline, slickline, coiled tubing, pipe, drill pipe, downhole tractor, or the like. In some embodiments, conveyance 110 may provide mechanical suspension, as well as electrical connectivity, for sonic logging tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. Electrical conductors may be used for communicating power and telemetry between vehicle 104 and sonic logging tool 102. Information from sonic logging tool 102 may be gathered and/or processed by information handling system 114. For example, signals recorded by sonic logging tool 102 may be stored on memory and then processed by sonic logging tool 102. The processing may be performed real-time during data acquisition or after recovery of sonic logging tool 102. Processing may alternatively occur downhole or may occur both downhole and at surface. In some embodiments, signals recorded by sonic logging tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to sonic logging tool 102.

Systems and methods of the present disclosure may be implemented, at least in part, with information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a processing unit 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as an input device 118 (e.g., keyboard, mouse, etc.) and a video display 120. Information handling system 114 may also include one or more buses operable to transmit communications between the various hardware components.

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

As illustrated, sonic logging tool 102 may be disposed in borehole 124 by way of conveyance 110. Borehole 124 may extend from a wellhead 134 into a formation 132 from surface 108. Generally, borehole 124 may include horizontal, vertical, slanted, curved, and other types of borehole geometries and orientations. Borehole 124 may be cased or uncased. In examples, borehole 124 may comprise a metallic material, such as tubular 136. By way of example, tubular 136 may be a casing, liner, tubing, or other elongated steel tubular disposed in borehole 124. As illustrated, borehole 124 may extend through formation 132. Borehole 124 may extend generally vertically into formation 132. However, borehole 124 may extend at an angle through formation 132, such as horizontal and slanted boreholes. For example, although borehole 124 is illustrated as a vertical or low inclination angle well, high inclination angle or horizontal placement of the well and equipment may be possible. It should further be noted that while borehole 124 is generally depicted as a land-based operation, those skilled in the art may recognize that the principles described herein are equally applicable to subsea operations that employ floating or sea-based platforms and rigs, without departing from the scope of the disclosure.

In examples, rig 106 includes a load cell (not shown) which may determine the amount of pull on conveyance 110 at surface 108 of borehole 124. While not shown, a safety valve may control the hydraulic pressure that drives drum 126 on vehicle 104 which may reel up and/or release conveyance 110 which may move sonic logging tool 102 up and/or down borehole 124. The safety valve may be adjusted to a pressure such that drum 126 may only impart a small amount of tension to conveyance 110 over and above the tension necessary to retrieve conveyance 110 and/or sonic logging tool 102 from borehole 124. The safety valve is typically set a few hundred pounds above the amount of desired safe pull on conveyance 110 such that once that limit is exceeded; further pull on conveyance 110 may be prevented.

In examples, sonic logging tool 102 may operate with additional equipment (not illustrated) on surface 108 and/or disposed in a separate borehole sonic logging system (not illustrated) to record measurements and/or values from formation 132. Sonic logging tool 102 may comprise a transmitter 128. Transmitter 128 may be connected to information handling system 114, which may further control the operation of transmitter 128. Transmitter 128 may include any suitable transmitter for generating sonic energy comprising at least one or more waveforms and/or sound waves into formation 132, including, but not limited to, piezoelectric transmitters. Transmitter 128 may be a monopole source, a multi-pole source (e.g., a dipole source, quadrupole source), high-order multipole, or any combination of multiple sources. Combinations of different types of transmitters may also be used. During operations, transmitter 128 may broadcast sound waves (e.g., sonic waveforms) from sonic logging tool 102 that travel into formation 132. The sound waves may be emitted at any suitable frequency range. For example, a broad band response could be from about 0.2 KHz to about 20 KHz, and a narrow band response could be from about 1 KHz to about 6 KHz. It should be understood that the present technique should not be limited to these frequency ranges. Rather, the sounds waves may be emitted at any suitable frequency for a particular application.

Sonic logging tool 102 may also include a receiver 130. As illustrated, there may be a plurality of receivers 130 disposed on sonic logging tool 102. Receiver 130 may include any suitable receiver for receiving sound waves, including, but not limited to, piezoelectric receivers. For example, the receiver 130 may be a monopole receiver or multi-pole receiver (e.g., a dipole receiver). Receivers 130 may be configured to measure a sonic wave field comprising at least one or more reflected waveforms and one or more direct and/or guided waveforms. Further, a monopole receiver 130 may be used to record compressional-wave (P-wave) signals, while the multi-pole receiver 130 may be used to record shear-wave (S-wave) signals. Receiver 130 may have the function of recording dipole signals from two directions that are perpendicular to each other. Receiver 130 may also have the function of recording quadrupole signals from two directions that are 45 degrees apart. In examples, signals recorded by receiver 130 may be digitally created by information handling system 114 in any direction to simulate dipole and quadrupoles measurements. Receiver 130 may measure and/or record sound waves broadcast from transmitter 128 as received signals. The sound waves received at receiver 130 may include both direct waves that traveled along the borehole 124 and refract through formation 132 as well as waves that traveled through formation 132 and reflect off of near-borehole bedding and propagate back to the borehole. The reflected waves may include, but are not limited to, compressional (P) waves and shear (S) waves. By way of example, the received signal may be recorded as an acoustic amplitude as a function of time. Information handling system 114 may control the operation of receiver 130. The measured sound waves may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124, fluids, and/or formation 132. By way of example, the sound waves may be processed to generate a reflection image of formation structures, which may be used for dip analysis as discussed in more detail below.

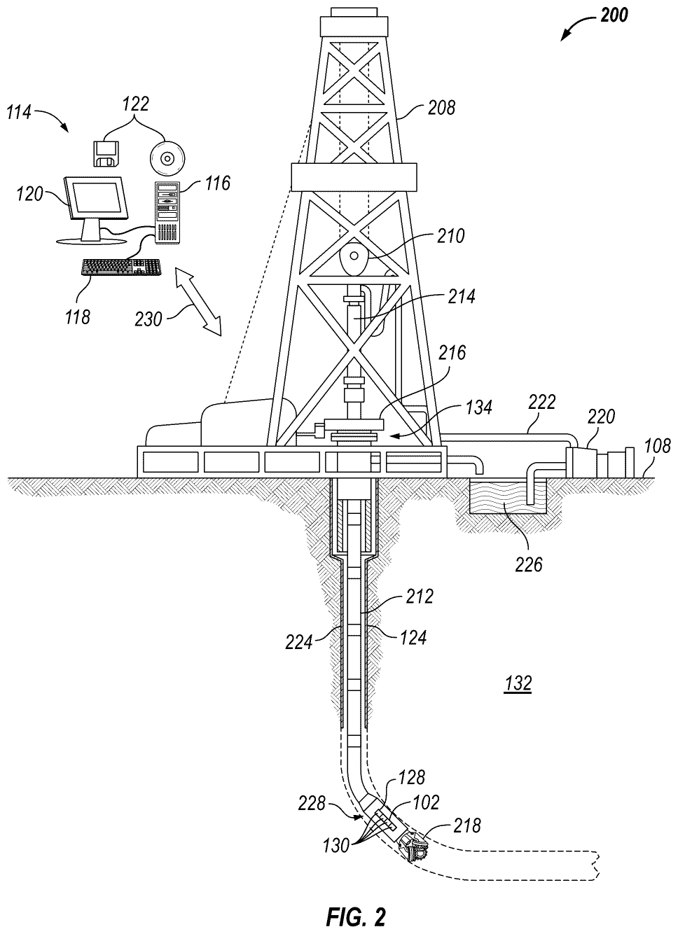

FIG. 2 illustrates an example of sonic logging tool 102 which may be included in a drilling system 200. As illustrated, borehole 124 may extend from wellhead 134 into formation 132 from surface 108. A drilling platform 206 may support a derrick 208 having a traveling block 210 for raising and lowering drill string 212. Drill string 212 may include, but is not limited to, drill pipe and coiled tubing, as generally known to those skilled in the art. A kelly 214 may support drill string 212 as it may be lowered through a rotary table 216. A drill bit 218 may be attached to the distal end of drill string 212 and may be driven either by a downhole motor and/or via rotation of drill string 212 from surface 108. Without limitation, drill bit 218 may include, roller cone bits, PDC bits, natural diamond bits, any hole openers, reamers, coring bits, and the like. As drill bit 218 rotates, it may create and extend borehole 124 that penetrates various subterranean formations 204. A pump 220 may circulate drilling fluid through a feed pipe 222 to kelly 214, downhole through interior of drill string 212, through orifices in drill bit 218, back to surface 108 via annulus 224 surrounding drill string 212, and into a retention pit 226.

With continued reference to FIG. 2, drill string 212 may begin at wellhead 134 and may traverse borehole 124. Drill bit 218 may be attached to a distal end of drill string 212 and may be driven, for example, either by a downhole motor and/or via rotation of drill string 212 from surface 108. Drill bit 218 may be a part of bottom hole assembly 228 at distal end of drill string 212. Bottom hole assembly 228 may further comprise sonic logging tool 102. Sonic logging tool 102 may be disposed on the outside and/or within bottom hole assembly 228. Sonic logging tool 102 may comprise a plurality of transmitters 128 and/or receivers 130. Sonic logging tool 102 and/or the plurality of transmitters 128 and receivers 130 may operate and/or function as described above. As will be appreciated by those of ordinary skill in the art, bottom hole assembly 228 may be a measurement-while drilling (MWD) and/or logging-while-drilling (LWD) system.

Without limitation, bottom hole assembly 228, transmitter 128, and/or receiver 130 may be connected to and/or controlled by information handling system 114, which may be disposed on surface 108. Without limitation, information handling system 114 may be disposed down hole in bottom hole assembly 228. Processing of information recorded may occur down hole and/or on surface 108. Processing occurring downhole may be transmitted to surface 108 to be recorded, observed, and/or further analyzed. Additionally, information recorded on information handling system 114 that may be disposed down hole may be stored until bottom hole assembly 228 may be brought to surface 108. In examples, information handling system 114 may communicate with bottom hole assembly 228 through a communication line (not illustrated) disposed in (or on) drill string 212. In examples, wireless communication may be used to transmit information back and forth between information handling system 114 and bottom hole assembly 228. Information handling system 114 may transmit information to bottom hole assembly 228 and may receive, as well as process, information recorded by bottom hole assembly 228. In examples, a downhole information handling system (not illustrated) may include, without limitation, a microprocessor or other suitable circuitry, for estimating, receiving and processing signals from bottom hole assembly 228. Downhole information handling system (not illustrated) may further include additional components, such as memory, input/output devices, interfaces, and the like. In examples, while not illustrated, bottom hole assembly 228 may include one or more additional components, such as analog-to-digital converter, filter and amplifier, among others, that may be used to process the measurements of bottom hole assembly 228 before they may be transmitted to surface 108. Alternatively, raw measurements from bottom hole assembly 228 may be transmitted to surface 108.

Any suitable technique may be used for transmitting signals from bottom hole assembly 228 to surface 108, including, but not limited to, wired pipe telemetry, mud-pulse telemetry, acoustic telemetry, and electromagnetic telemetry. While not illustrated, bottom hole assembly 228 may include a telemetry subassembly that may transmit telemetry data to surface 108. Without limitation, an electromagnetic source in the telemetry subassembly may be operable to generate pressure pulses in the drilling fluid that propagate along the fluid stream to surface 108. At surface 108, pressure transducers (not shown) may convert the pressure signal into electrical signals for a digitizer (not illustrated). The digitizer may supply a digital form of the telemetry signals to information handling system 114 via a communication link 230, which may be a wired or wireless link. The telemetry data may be analyzed and processed by information handling system 114.

As illustrated, communication link 230 (which may be wired or wireless, for example) may be provided which may transmit data from bottom hole assembly 228 to an information handling system 114 at surface 108. Information handling system 114 may include a processing unit 116, a video display 120, an input device 118 (e.g., keyboard, mouse, etc.), and/or non-transitory computer-readable media 122 (e.g., optical disks, magnetic disks) that may store code representative of the methods described herein. In addition to, or in place of processing at surface 108, processing may occur downhole.

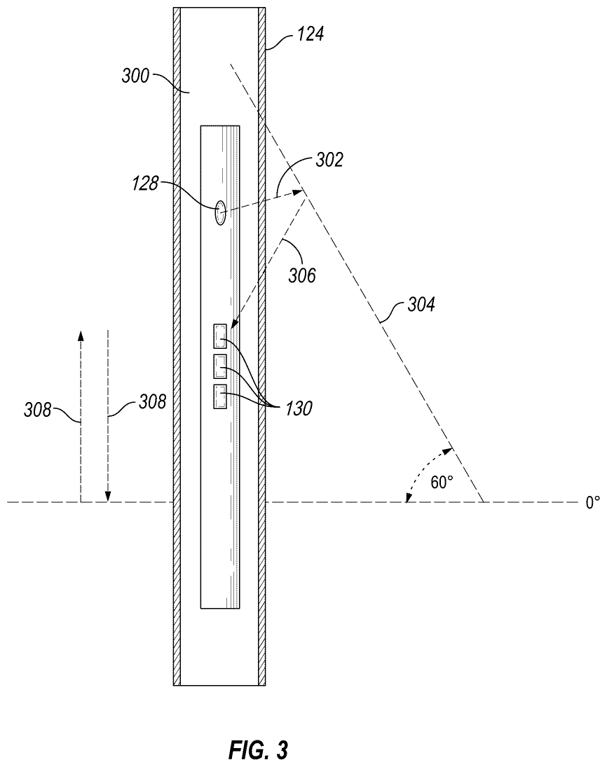

FIG. 3 illustrates an example of reflected wave imaging with sonic logging tool 102. As illustrated, sonic logging tool 102 may be disposed in a borehole 124, which may be filled with fluid 300. In examples, transmitter 128 may emit sonic waveforms 302 into borehole 124. In examples, at least one sonic waveform 302 may travel into formation 132 and may be reflected as a reflected waveforms 306 by a reflector 304 in formation 132. Herein, reflector 304 is assigned 60 degrees from the axial axis of downhole tool 102, but a reflector may take any possible angle. Reflected waveforms 306 may also be referred to as a reflected wave. Without limitation, reflector 304 may be a formation boundary, a fault, a cave, or a fracture. In examples, reflected waveforms 306 may travel back to borehole 124 and may be captured by receivers 130 in borehole 124. Simultaneously, sonic waveforms 302 signals which may become trapped in borehole 124 as borehole guide waves 308 may propagate along the axis of borehole 124 and may be captured by receivers 130. In examples, borehole guide waves 308 may be larger in amplitude than the reflected waveforms 306, which may reflect from reflector 304 away from borehole 124. For example, borehole guide waves 308 may prevent Reflected waveforms 306 from being recorded or may be recorded over reflected waveforms 306. In other situations, borehole 124 may be “washed out”, meaning that the borehole diameter increases over a short interval due to the formation sloughing off the borehole wall from any number of reasons, such as shales becoming hydrated and damaged, or sandstones becoming unlithified, or stress relief of the region near the borehole wall. In these cases when the borehole changes diameter, guided waves 308 may reflect off of the “washed out” zone and contribute to the unwanted signals that are recorded.

Reflected waveforms 306 may be captured utilizing the same type of transmitter 128 and receiver 130. For example, both transmitter 128 and receiver 130 may be a monopole or a dipole. As illustrated in FIG. 3, both borehole guided waves 308 and Reflected waveforms 306 may be recorded by receiver 130. Generally, a filtering procedure may remove borehole guided waves 308, which may be considered noise when imaging with reflected waveforms 306. In examples, the apparent velocity of reflected waveforms 306 may be calculated with Equation (1):

$$Cos ( theta ) = \frac{Vtrue}{Vapparent} < 1 \qquad Equation ( 1 )$$

Herein theta may be the angle from the downhole axis between downhole tool 102 and reflector 304, Vtrue may be the true velocity, and Vapparent may be the apparent velocity as measured by receivers 130 on the tool.

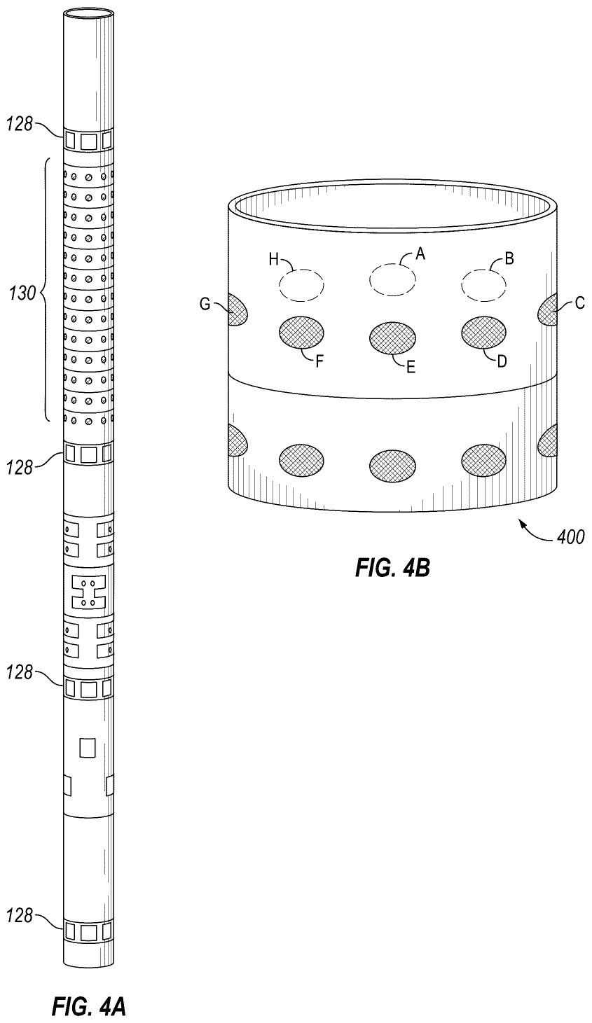

FIG. 4A illustrates an example of sonic logging tool 102. As illustrated, sonic logging tool 102 may comprise one or more transmitters 128 as well as one or more receivers 130. Generally, a single source to receiver offset location of receivers 130 may be defined as a “ring,” as receivers 130 may be disposed around sonic logging tool 102 in a ring 400. As noted above, both transmitters 128 and receivers 130 may be implemented as monopoles, dipoles, or quadrupoles. During measurement operations, when a transmitter 128 fires, the data from receivers 130 may be digitized and recorded by information handling system 114. As sonic logging tool 102 may traverses up and down borehole 124, transmitter 128 may transmit one or more acoustic waves about every 0.5 feet, which may result in about four hundred sets of “common shot” data over one hundred feet of borehole 124.

FIG. 4B illustrates any number of transmitters 128 and/or receivers 130 in a ring 400 that may be spaced apart at any distance. Additionally, sonic logging tool 102 may comprise thirteen rings 400 of receivers 130, each with multiple azimuthal receivers 130, fifty-two waveforms may be recorded. These waveforms may be processed separately, added together, or subtracted appropriately from each other to create monopole, dipole, or quadrupole waveforms utilizing information handling system 114. The waveforms from these elements may be labeled A, B, C, and D, for example. The combined waveforms may be labeled as XX, XY, YX, and YY for example, depending upon how the waveforms may be combined between firing direction of transmitter 128 and orientation direction(s) of receiver 130.

As discussed above, sonic logging tool 102 may comprise one or more rings 400 of receivers 130. Reflected waveforms 306 recorded by a single ring 400 or receivers 130 may be identified as waveform data. Regardless of how the waveforms from the multiple receivers 130 of a ring 400 may be combined, all the waveforms from one receiver 130 may be identified as waveform data from a single ring, where a receiver ring 400 is the source to receiver offset index of a set of receivers 130.

Generally, during measurement operations, waveforms recorded from all receivers 130 from a single source firing are processed to extract the formation velocity for a single depth. In this disclosure, the data may be analyzed in common receiver fashion-meaning only the waveform data from a single ring 400, from all the shots are analyzed. For example, when transmitter 128 sonic logging tool 102 fires in borehole 124, acoustic waves may be generated in fluid 300 in borehole 124. Sonic waveforms 302 in fluid 300 may additionally couple to a wall of borehole 124 and may create a series of guided waves, also called modes, propagating along borehole 124. These various modes include the pseudo-Rayleigh wave, Stoneley wave, and leaky P-wave. In addition to those waves propagating in borehole 124 are P- and S-body waves that leave outward from borehole 124 and may travel into formation 132. These waves may encounter reflectors 304 from changes in the rock layering, vugs, fractures, faults, etc. away from the borehole and then be reflected back toward borehole 124 and recorded by receivers 130 in sonic logging tool 102. These waves are typically much smaller in amplitude than the borehole guided waves and may be utilized for creating migrated images of formation 132.

Generally, images formed to show reflectors 304 away from borehole 124 using full waveform sonic data have been performed in the industry. However, finding sonic data that is appropriate for imaging has been problematic. This is because it is difficult to ascertain if the raw sonic data contains reflection data of sufficient quality and amplitude to create images. Many other types of waves exist in the raw data-including reflected waves from borehole break outs (also known as “wash outs”) and formation interfaces at the borehole. This fact has required extensive preprocessing and migration imaging tests of the data before determining if there are quality reflections. These imaging tests can be computationally intensive and subject to interpretation. Discussed below are methods that may be utilized with a system to identify quality reflections that are objective and less computationally intensive.

As discussed above, velocity analyses may be formed from the measurements taken during measurement operations described above. The output of a velocity analysis may comprise of a table of values representing the coherence of waves propagating on an analyzed data set. Each value in the table is the coherence value formed by aligning the traces in a set of input traces with a trial velocity (or slowness). If one or more events on the traces align well with that trial velocity, a high value of coherence may be derived. If the traces do not align well, then a low value of coherence may be derived. The values in the velocity analysis table may be rendered visible to a user in one of many ways, including a color map, numerical values, or a contour plot. The velocity analysis created from a slant stack (or tau-p) analysis may have one axis of the table indexed by trial velocities, and the other axis by time down one of the input traces. The velocity analysis created from a circular velocity analysis may have one axis of the table indexed by the trial velocity, and the other axis indexed by the trace number (or location of the trace).

In examples, one such velocity analysis may be a velocity scan revealing the apparent velocities of reflected waveforms 306 recorded by receivers 130 on a full waveform sonic log data coming from sonic logging tool 102. The result of the velocity scan may allow for the determination of the suitability of the data for forming migrated images of the reservoir around borehole 124. Several factors may be taken into consideration when forming a velocity scan. These considerations may be accounted for in preprocessing of the recorded data from receivers 130. For example, during measurement operations undesirable acoustic waveforms may be formed from banging or hitting of sonic logging tool 102 against a wall of borehole 124, which may create large and/or small noise spikes in the data. These spikes may be modified by any number of filtering processes that information handling system 114 may implement to create usable data from the waveforms recorded by sonic logging tool 102. However, these spikes, if present, may be detrimental to the imaging process. Therefore, these spikes may be removed by de-spiking methods such as, median filtering, threshold detection, or automatic gain control. In examples any preprocessing techniques may be applied. In addition, the traces may be added or subtracted from each other prior to processing.

Additionally, it may be helpful to limit the frequency bandwidth of the waveform data to be within the expected range for the wave type that is to be processed. For example, P-waves may have a higher frequency content than the S-waves. Stoneley waves may have a lower frequency. Thus, it is easy to limit the bandwidth of the data to the expected frequency range for the wave type of interest. Other considerations may target guided modes, also called direct waves. Direct waves may be waveforms that propagate from transmitter 128 to receiver(s) 130 directly along borehole 124. In examples, the direct P- and S-waves may be defined as head waves, which may be guided waves within borehole 124. Generally, the S head wave is a pseudo-Rayleigh wave which propagates as a complicated waveguide mode. In slow formations, the P head wave also may show very complicated waveguide effects.

Another factor to consider is that a Stoneley wave is a guided wave which may be trapped in borehole 124 and is strongly influenced by the mud velocity in borehole 124. All of these guided waves may be used to extract formation slowness properties. However, for imaging purposes guided waves are considered noise and optimally should be removed from the data before a slant stack analysis is performed. Guided waves may be removed by any number of methods including simple median filtering, or alignment followed by median filtering. It may also be possible to limit which waves are present in the waveform data by performing frequency wavenumber filtering. In this approach, the moveout characteristics of the events may be used to remove selective waves or a set of waves from the data.

After the data may be preprocessed, as discussed above, the data may be separated into sets of waveforms based upon which receiver 130 the data may have been recorded from and their depth range. For each set of traces from the same receiver 130, or ring 400, the traces or waveforms may be sorted into either ascending or descending measured depth. A velocity scan is then performed on each sorted ring 400. A velocity scan may comprise a circular velocity scan and/or a full velocity scan.

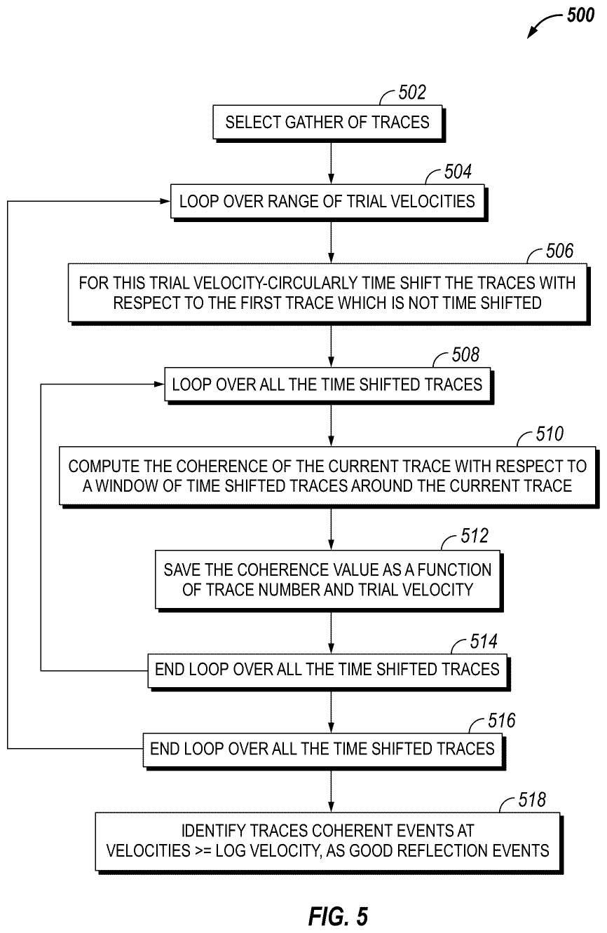

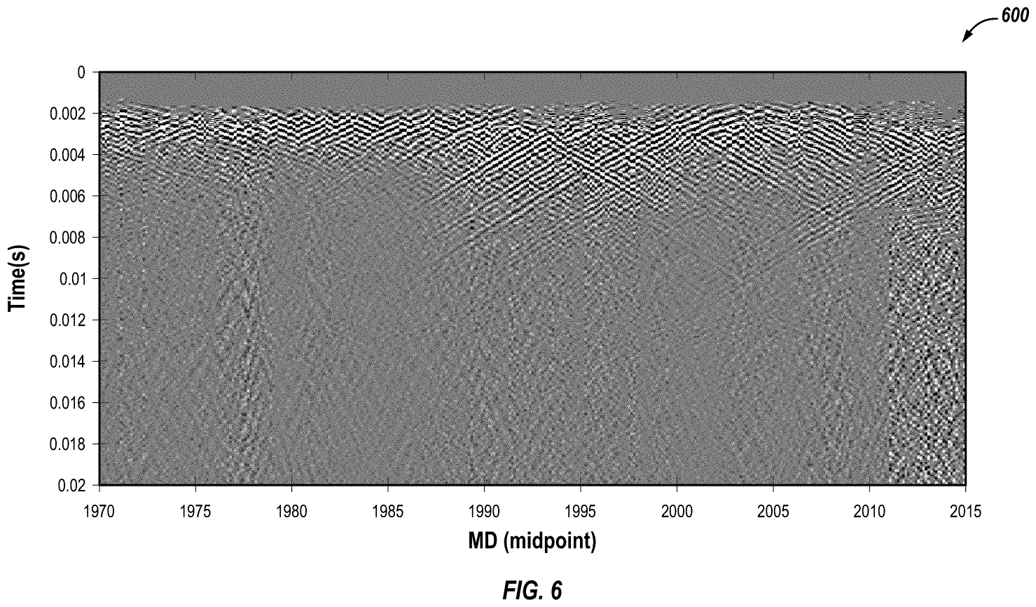

FIG. 5 illustrates workflow 500 for a circular velocity scan. In examples, workflow 500 may be performed on information handling system 114. The circular velocity scan may be utilized to determine if there is coherent energy (or waves) propagating as reflections hit transmitters 128 on sonic logging tool 102 (e.g., referring to FIG. 3). Workflow 500 may begin with block 502 in which a group of one or more traces may be selected from sets of recorded waveforms 306 (e.g., referring to FIG. 4) collected by transmitters 128 or single ring 400. Each trace is a recorded time series measurement from one of the receivers which measures the full sonic wavefield. Alternatively, as we have described previously, it is the sum or difference of the measurements from the receivers in one ring. Selecting one or more traces from sets of waveforms may comprise searching for reflection events on the sonic data which have a moveout, or alignment, across a subset of the full set of traces in a linear fashion. FIG. 6 illustrates input traces 600 acquired by sonic logging tool 102 (e.g., referring to FIG. 1).

Referring back to FIG. 5, in block 504, an initial trial velocity may be selected to analyze one or more reflected waveforms 306 from block 502. The set of trial velocities may be selected from at least a sonic profile of every trace. The sonic profile may comprise all velocities from every trace. The minimum value in the set of trial velocities may be the slowest velocity in the profile, the maximum value may be the expected formation dip, and every value between may be linearly spaced. In examples, a trial velocity may be selected from a set of trial velocities, where each trial velocity from the set of trial velocities creates a linearly spaced function over the total range of reflected waveforms 306. In addition to a linear function, any other function may apply as well, and the set of trial velocities may be any number. The initial trial velocity may be selected as the first, a middle, or the last velocity from the set of trail velocities. Block 504 may be repeated for every trial velocity from the set of trial velocities. In block 506, each trace from the group of traces may be linearly time shifted based upon a range of velocities (or slowness) of moveout across the gather.

The traces may be time shifted using a circular time shift. For example, in a circular time shift, least part of the trace may be wrapped around the rest of the trace. The extent to which the trace is wrapped is because of the linear time shift. Block 506 linearly and circularly time shifts the selected traces to form time shifted traces. In examples, linear time shift followed by a circular time shift may be performed using a fast Fourier transform (FFT) or a discrete Fourier transform with the same number of samples as each trace. In the frequency domain, a time shift may be implemented as a phase shift, according to the time delay or shift desired. If the traces are not padded, the data that falls off the beginning (or end) of each trace is merely circularly rotated around to the end (or beginning) of the trace. Energy that is propagating at the current “test” velocity (or slowness) may be aligned in time. The product forms time shifted traces.

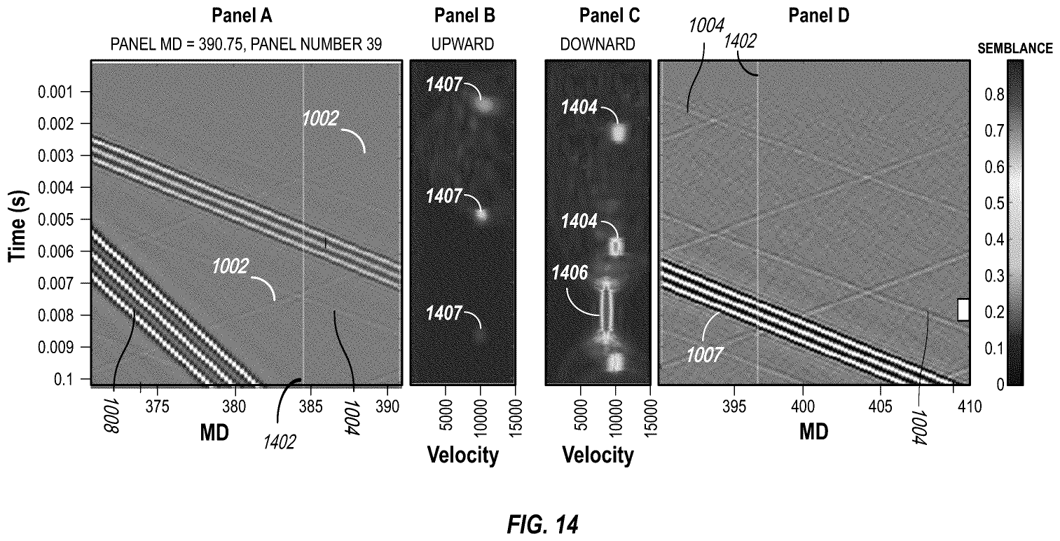

In block 508, a second trial velocity from the set of trial velocities from block 506 may be selected. The selection of the second trial velocity may be random, or it may be selected by a selection algorithm. In block 510, coherence of the may be calculated between two or more traces from the shifted group of traces from block 506. The coherence may be computed using any number of measurements like semblance, normalized energy, or zero lag cross correlation value. The output of the circular velocity scan is a 2D map plot of trace number or location on one axis and velocity on the other axis. The value of the map will be the coherence value for each trace location versus trial velocity. A coherence measurement, such as the zero-lag correlation coefficient or the semblance is computed for the entire trace, for this test velocity (or slowness). In block 512, the coherence from block 510 may be recorded into a table of coherence value with its shifted trial velocity and depth. The table may be indexed by trial velocity and depth of the shifted trace. In addition, the coherence value may be stored into a circular velocity analysis panel. In block 514, blocks 508-512 may be repeated for a new trial velocity from the set of trial velocities, for a new shifted trace selected from block 506 until all traces process through blocks 510 and 512. In block 516, a new trial velocity is selected in block 504, as previously described. Each trial velocity iterated for blocks 506-514. As a result, a velocity analysis panel A (e.g., referring to FIG. 14) comprising each shifted trace may be formed for every velocity.

In block 518, the circular velocity analysis panel may be searched to find large coherence values which are used to build an image of a reflector. Reflector 304 (e.g., referring to FIG. 3) in the formation 132 (e.g., referring to FIG. 1) may be identified from the table of coherence values computed from the shifted group of shifted traces which aligns reflected waves traveling at the trial apparent velocity if its coherence is large enough. In addition, valid reflection events will have velocities equal or larger than the log velocity for that depth. An image of reflector 304 may be formed with the trial velocity and depth of the shifted group of traces if its coherence is large enough. Herein, a large enough coherence value may be a value that locally exceeds the values nearby. In addition, there may be a threshold which qualifies a coherence value as being large enough. If the coherence value is large enough it means there is a reflection at the depth and recorded in the circular velocity analysis panel. The threshold may range from 0.01-. 1, 0.1-. 5, 0.5-. 9, 0.9-. 99, or more. If semblance or normalized cross correlation coherence metrics are used, then values closer to unity are preferred, however as the waveforms may not be very similar shape and amplitude, these values may be lower in numerical value. In addition, there may be any number of reflectors from which waveforms may reflect off of in the formation. Herein, only one is disclosed for visualization.

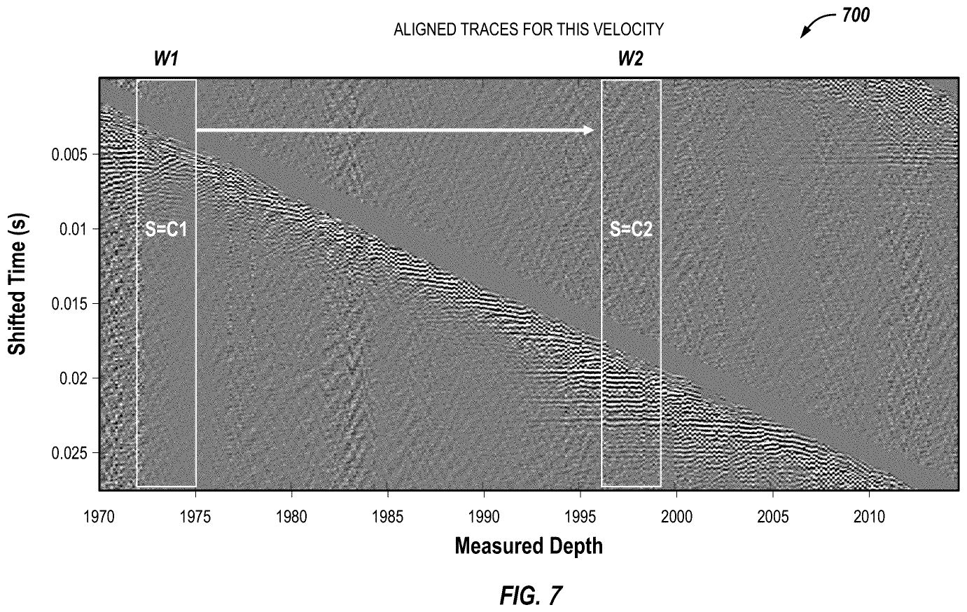

FIG. 7 illustrates circularly shifted traces 700. Herein, circularly shifted traces 700 are shown to be shifted by a trial velocity of 3315 m/s, however any other shift amount may be suitable. As shown in FIG. 7, W/illustrates the first window of a first trial velocity from the set of trial velocities with a first computed coherence C1. Similarly, W2 illustrates a second window of the same trial velocity from the set of trial velocities with a second computed coherence C2.

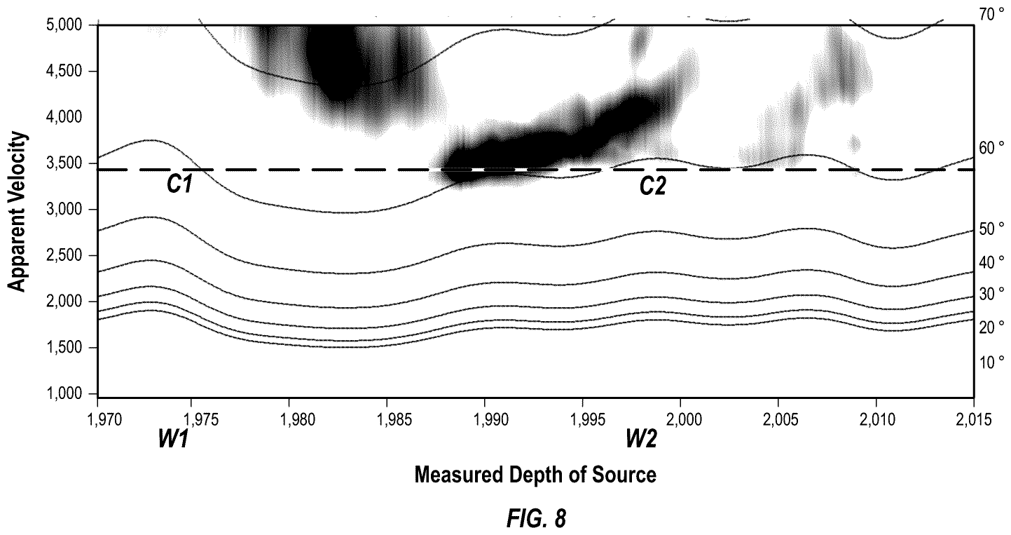

FIG. 8 illustrates a table in the form of an image of the coherence computed at many depth locations (along the horizontal axis) and a range of trial velocities (along the vertical axis). The trial velocity used in FIG. 7 to circularly shift the traces is shown as the horizontal line at apparent velocity of 3315 m/s. The first window W1, in FIGS. 7 and 8, denote the depth location where the coherence of the shifted traces was computed and plotted at the location of computed coherence C1 on FIG. 8. Computed coherence C2 in FIG. 8 was computed for the depth window W2.

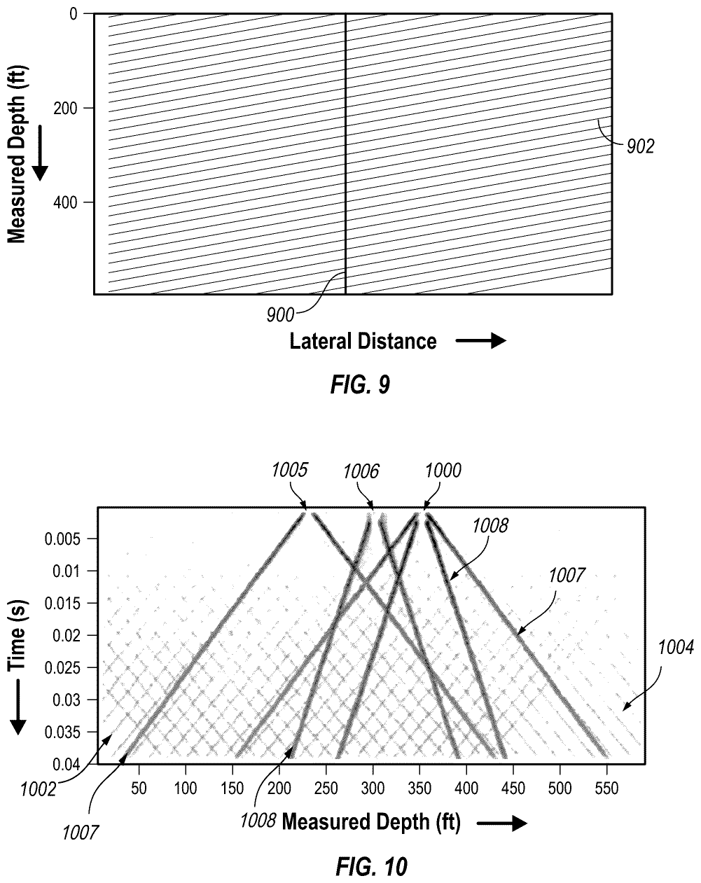

FIG. 9 shows a simple model of a vertical well with formation layers dipping at twenty-five degrees at point 900. Additionally, FIG. 9 illustrates the geometry of borehole 124 (e.g., referring to FIG. 1) and dipping formation layers 902. Each of these formation boundaries will reflect sonic energy back to the borehole when the transmitter 128 is fired in the borehole and energy propagates away from the borehole and is reflected by the formation layers 902 back to the borehole 124 and measured by the receivers 130. FIG. 10 also illustrates a synthetic sonic waveform gathered from a single ring where the direct waves have already been removed. For more realism, the synthetic data includes shear wave reflections 1007 off of borehole breakouts 1005 and 1000 at depths of about 230 ft and 300 ft., and Stoneley waves reflections 1008 off of borehole breakouts 1006 and 1000 at depths of 300 ft and 350 ft. The desired reflections off the dipping formation bedding to be identified show up as up going 1002 and down going events 1004.

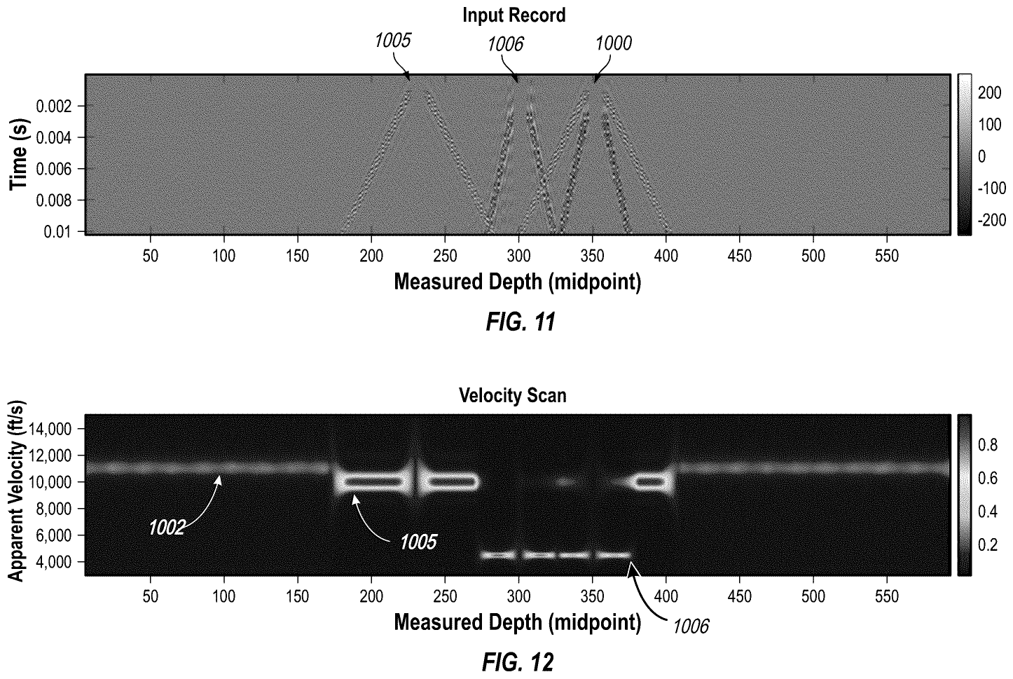

FIG. 11 illustrates the circular velocity scan input record utilizing workflow 500 (e.g., referring to FIG. 5) of the synthetic data in FIG. 7. FIG. 12 illustrates the circular velocity scan utilizing workflow 500 (e.g., referring to FIG. 5) of the synthetic data in FIGS. 7 and 11. The formation velocity for the modeled data is 10,000 ft/s but because the beds are dipping with respect to the well bore at point 900, they appear at an apparent velocity of about 11,000 ft/s. However, the reflected shear waves 1007 from the borehole breakouts appear at their true formation velocity of 10,000 ft/s. Additionally, the Stoneley waves 1008 from the borehole breakouts 1006 and 1000 appear at velocity 4,000 ft/s. From this analysis, it is clear that events propagating at speeds equal to or greater than the formation shear velocity may be useful for imaging the formation boundaries. Events which are propagating slower than the formation shear wave velocity (as determined by the sonic velocity logs) may not be from the formation bed boundaries or fractures and faults. The circular velocity scan utilizing workflow 500 may also be utilized with a full velocity scan.

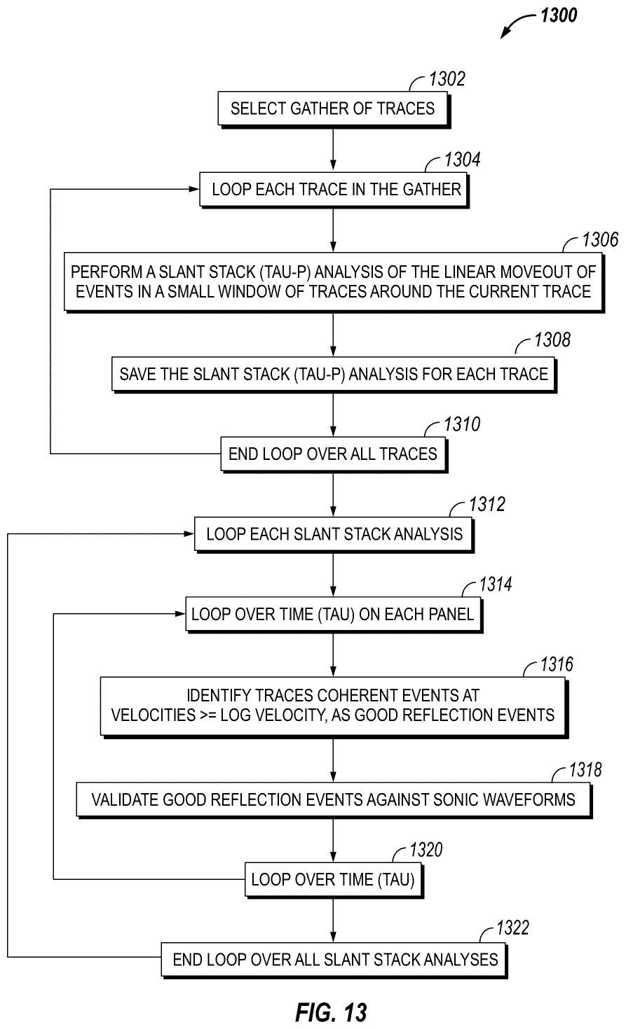

FIG. 13 illustrates workflow 1300 for a full velocity scan. In examples, workflow 1300 may be performed on information handling system 114. Workflow 1300 may be utilized to extract a fine detailed analysis of the data from a ring 400 (e.g., referring to FIG. 4) to reveal not only which depth level has valid reflection data, but also to be able to identify which event recorded by ring 400 shows that velocity characteristic. Workflow 1300 may begin with block 1302 in which one or more traces may be selected from sets of waveforms collected by receivers 130 (e.g., referring to FIG. 4) or single ring 400. Selecting one or more traces from sets of waveforms may comprise searching for reflection events on the sonic data which have a moveout, or alignment, across a subset of the full set of traces in a linear fashion. Each selected trace may be sorted into monotonically ascending (or alternatively monotonically descending) order to form a list of selected traces.

In block 1304, the next (i.e., first for the first iteration) trace is selected from the list of selected traces from block 1302 to form a current trace. In block 1306, a slant stack (tau-p) analysis may be performed over a small window of traces around the current trace. A slant stack (tau-p) analysis may comprise computing the coherence of the data in this depth window for a range of velocities as a function of time down the current trace. A slant stack (tau-p) analysis may be an analysis tool used on acoustic and seismic waveform data of many types, acquired as a set of traces measured in time on one axis and distance on the other axis which converts the data to the time delay (on one axis) and slowness (on the other axis) domain. The slant stack (tau-p) analysis computes the alignment of events moving along the traces with a linear moveout velocity. A measure of the coherence of that time window across all of the traces in the set of traces is computed with each of the trial linear velocities. Thus, the output of the slant stack analysis is a 2D map plot showing for each time sample of one of the input traces whether there are events moving across the set of traces over the range of test velocities (or slowness). To use the slant stack analysis on the set of sonic traces, a set of slant stack 2D map plots may be created, one for each set of sub-selected traces from the full sonic data set. In block 1308, the slant stack (tau-p) analysis may be saved for each trace into a slant stack (tau-p) analysis depository. In block 1310, blocks 1304-1308 may be iterated, each time with a next trace for every trace from the list of selected traces. As a result, a slant stack (tau-p) analysis depository may comprise the same amount of analysis as traces from the list of selected traces.

In block 1312, the next (i.e., first for the first iteration) analysis is selected from a slant stack (tau-p) analysis depository from block 1312 to form a current analysis. In block 1314, the next delay tau (i.e., first for the first iteration) may be selected. In block 1316, coherent events at velocities, which are greater than or equal to log velocities may be identified as good reflection events. Thus, the circular velocity analysis allows for a quick way to scan the sonic data for events propagating across the traces with a velocity equal to or faster than the the formation velocity. The slant stack analyses are used then to get a detailed analysis of not only the trace (depth) location of the desired waves, but also the arrival times (from the tau value) on the 2D map plot. In blocks 1320 and 1322, the loops in blocks 1312 and 1314 are needed, respectively.

FIG. 14 illustrates an example image formed from workflow 1300 (e.g., referring to FIG. 10) utilizing a full slant stack analysis for one trace location. The depth of the trace being analyzed is at 390.75 ft. The traces in panel A show a depth range of input traces above the selected analysis trace. The traces in panel D show a depth range of input traces below the selected analysis trace. Vertical lines 1402 show the range of traces used in the slant stack analysis for the selected trace. In panel B is shown the slant stack analysis for upgoing velocities (i.e., events propagating in the “leftward” direction in panels A and B from the selected trace). In panel C is shown the slant stack analysis for down going velocities (i.e., events propagating in the “rightward” direction in panels A and D. Coherence (semblance) values 1404 indicate the presence of coherent reflected sonic data propagating at speeds faster than the formation velocity and thus of keen interest for imaging. Linear moveout of sonic energy is identified as 1406 in the selected range of traces being analyzed are from reflected shear waves 1007 off of borehole breakout 1000 and so are not of interest for imaging.

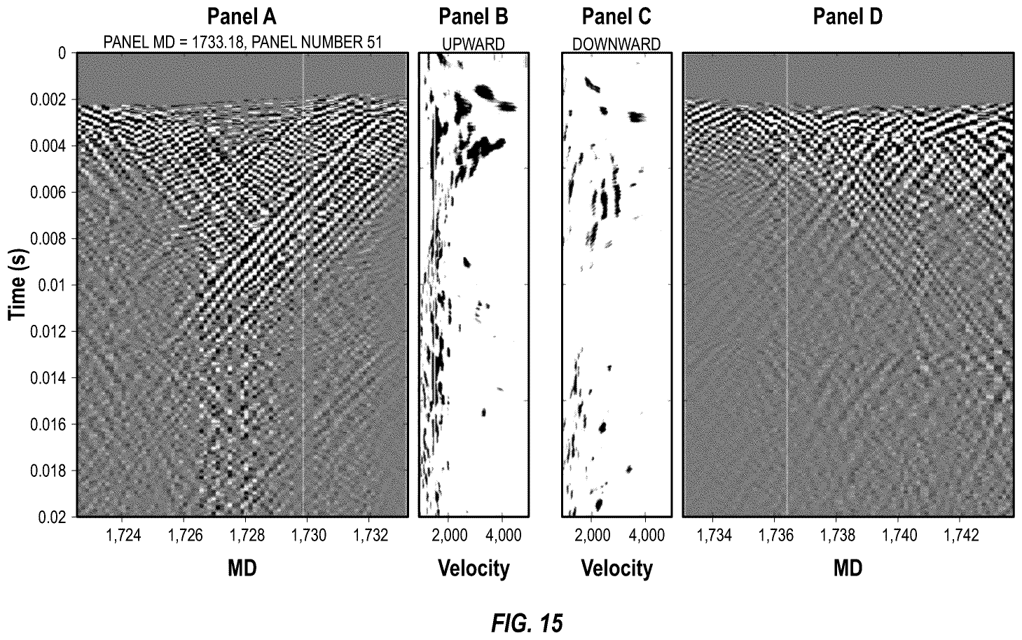

In panel B three events 1407 may be propagating upward at about 11,000 ft/s at times of approximately 0.0015 s, 0.0045 s, and 0.009 s. These correspond to the upward propagating formation reflection events 1002. The three downward formation reflection events 1004 shown in panels A and D are shown in panel C, to be propagating at about 11,000 ft/s at times of 0.002 s, 0.006 s, and 0.0095 s. Another event 1406 may be seen between about 0.007 and 0.0085 s propagating at the shear velocity of 10,000 ft/s. This is from a shear reflection 1007 off of the borehole breakout 1000. These events are verified by examining the traces shown in panels A and D. As discussed above, any event propagating slower than the formation velocity may not be from reflections away from reflector 304 (e.g., referring to FIG. 3), like borehole bedding, fractures, faults, or vugs, away from the borehole. Those therefore can be discarded. FIG. 15 illustrates another example of an image formed from workflow 1300 (e.g., referring to FIG. 10) utilizing field data.

Workflows 500 and 1000 may be utilized as improvements over current technology. Specifically, conventional sonic log velocity (or slowness) analyses are performed on direct waves. The reflected waves are considered noise. Conventional methods assume a transmission of the sonic waves across the array of receivers on a sonic logging tool. In contrast, the geometry of the analysis in workflows 500 and 1000 is changed to be for only reflected waves. The direct waves are filtered out of the input data, and the intent is to only analyze the reflections off features in the formation away from the borehole up to 100's of feet. In addition, the velocities (or slowness) derived by this new process are apparent velocities, not the actual formation velocity (or slowness). This is because the waves are being reflected from features not near the borehole. These apparent velocities (or slowness) will also appear faster than the actual formation velocity (slowness) because they may be dipping away from the borehole. The new methods described above allow raw data to be quickly preprocessed and tested to characterize whether there are enough quality reflections in the data to invest the time to perform the actual migration imaging of the data.

This method and system may include any of the various features of the compositions, methods, and system disclosed herein, including one or more of the following statements.

Statement 1. A method for locating a reflector in a formation comprising: disposing a borehole sonic logging tool into a borehole disposed in a formation, wherein the borehole sonic logging tool comprises: a transmitter configured to transmit sonic energy comprising at least one or more waveforms into a formation; and one or more receivers configured to record a sonic wave field comprising at least one or more reflected waveforms and one or more direct and/or guided waveforms; selecting a group of traces from at least the one or more reflected waveforms or the one or more direct, or the guided waveforms; selecting a set of trial velocities from at least a sonic profile; selecting an initial trial velocity from the set of trial velocities; shifting the group of traces by the initial trial velocity to form a shifted group of traces; computing a coherence value between at least two or more traces from the shifted group of traces; recording the coherence value for the shifted group of traces at its initial trial velocity and depth; and determining if there are reflections for imaging the formation based at least on the coherence.

Statement 2. The method of statement 1, wherein the minimum value in the set of trial velocities is the slowest velocity in the profile and the maximum value is based upon an expected formation dip and fastest velocity in the profile.

Statement 3. The method of statements 1 or 2, wherein each trial velocity from the set of trial velocities is determined by a linearly spaced function over the range of the set of trial velocities.

Statement 4. The method of statements 1-3, further comprising updating the initial trial velocity with a new trial velocity.

Statement 5. The method of statements 1-4 wherein the shifting the group of traces is performed by a circular time shift.

Statement 6. The method of statement 5, wherein at least part of a shifted trace from the shifted group of traces is wrapped around itself.

Statement 7. The method of statements 5 or 6, wherein the circular time shift may be performed by a fast Fourier transform or discrete Fourier transform.

Statement 8. The method of statements 1-7, wherein the coherence value is computed by semblance, normalized energy, or zero lag cross correlation value.

Statement 9. The method of statements 1-8, further comprising forming a table of the coherence values indexed by the trial velocity and the depth of the shifted group of traces.

Statement 10. The method of statement 9, wherein a reflector is identified from the table of coherence values computed from the shifted group of traces which aligns reflected waves traveling at the trial apparent velocity if its coherence is large enough.

Statement 11. The method of statements 1-10, wherein the one or more waveforms and the one or more reflected waveforms are sonic data from the formation.

Statement 12. A system comprising: a borehole sonic logging tool comprising: a transmitter configured to transmit sonic energy comprising at least one or more waveforms into a formation; and one or more receivers configured to record a sonic wave field comprising at least one or more reflected waveforms and one or more direct and/or guided waveforms; and an information handling system configured to: select a group of traces from at least the one or more reflected waveforms or the one or more direct, or the guided waveforms; select a set of trial velocities from at least a sonic profile; select an initial trial velocity from the set of trial velocities; shift the group of traces by the initial trial velocity to form a shifted group of traces; compute a coherence value between at least two or more traces from the shifted group of traces; record the coherence value for the shifted group of traces at its initial trial velocity and depth; and determine if there are reflections for imaging the formation based at least on the coherence.

Statement 13. The system of statement 12, wherein the minimum value in the set of trial velocities is the slowest velocity in the profile and the maximum value is based upon an expected formation dip and fastest velocity in the profile.

Statement 14. The system of statements 12 or 13, wherein each trial velocity from the set of trial velocities is determined by a linearly spaced function over the range of the set of trial velocities.

Statement 15. The system of statements 12-14, wherein the information handling system is configured to update the initial trial velocity with a new trial velocity.

Statement 16. The system of statement 12-15, wherein the shifting the group of traces is performed by a circular time shift.

Statement 17. The system of statement 16, wherein at least part of a shifted trace from the shifted group of traces is wrapped around itself.

Statement 18. The system of statements 16 or 17, wherein the circular time shift may be performed by a fast Fourier transform or discrete Fourier transform.

Statement 19. The system of statements 12-18, wherein the coherence value is computed by semblance, normalized energy, or zero lag cross correlation value.

Statement 20. The system of statements 12-19, wherein the information handling system is configured to a table of the coherence values indexed by the trial velocity and the depth of the shifted group of traces.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for locating a reflector in a formation comprising:
disposing a borehole sonic logging tool into a borehole disposed in a formation, wherein the borehole sonic logging tool comprises:
a transmitter configured to transmit sonic energy comprising at least one or more waveforms into the formation; and
one or more receivers configured to record a sonic wave field comprising at least one or more reflected waveforms and one or more direct and/or guided waveforms;
selecting a group of traces from at least the one or more reflected waveforms or the one or more direct, or the guided waveforms;
selecting a set of trial velocities from at least a sonic profile;
selecting an initial trial velocity from the set of trial velocities;
shifting the group of traces by the initial trial velocity to form a shifted group of traces;
computing a coherence value between at least two or more traces from the shifted group of traces;
recording the coherence value for the shifted group of traces at its initial trial velocity and depth; and
determining if there are reflections for imaging the formation based at least on the coherence.

2. The method of claim 1, wherein the minimum value in the set of trial velocities is the slowest velocity in the profile and the maximum value is based upon an expected formation dip and fastest velocity in the profile.

3. The method of claim 1, wherein each trial velocity from the set of trial velocities is determined by a linearly spaced function over the range of the set of trial velocities.

4. The method of claim 1, further comprising updating the initial trial velocity with a new trial velocity.

5. The method of claim 1, wherein the shifting the group of traces is performed by a circular time shift.

6. The method of claim 5, wherein at least part of a shifted trace from the shifted group of traces is wrapped around itself.

7. The method of claim 5, wherein the circular time shift may be performed by a fast Fourier transform or discrete Fourier transform.

8. The method of claim 1, wherein the coherence value is computed by semblance, normalized energy, or zero lag cross correlation value.

9. The method of claim 1, further comprising forming a table of the coherence values indexed by the trial velocity and the depth of the shifted group of traces.

10. The method of claim 9, wherein a reflector is identified from the table of coherence values computed from the shifted group of traces which aligns reflected waves traveling at the trial apparent velocity if its coherence is large enough.

11. The method of claim 1, wherein the one or more waveforms and the one or more reflected waveforms are sonic data from the formation.

12. A system comprising:
a borehole sonic logging tool comprising:
a transmitter configured to transmit sonic energy comprising at least one or more waveforms into a formation; and
one or more receivers configured to record a sonic wave field comprising at least one or more reflected waveforms and one or more direct and/or guided waveforms; and
an information handling system configured to:
select a group of traces from at least the one or more reflected waveforms or the one or more direct, or the guided waveforms;
select a set of trial velocities from at least a sonic profile;
select an initial trial velocity from the set of trial velocities;
shift the group of traces by the initial trial velocity to form a shifted group of traces;
compute a coherence value between at least two or more traces from the shifted group of traces;
record the coherence value for the shifted group of traces at its initial trial velocity and depth; and
determine if there are reflections for imaging the formation based at least on the coherence.

13. The system of claim 12, wherein the minimum value in the set of trial velocities is the slowest velocity in the profile and the maximum value is based upon an expected formation dip and fastest velocity in the profile.

14. The system of claim 12, wherein each trial velocity from the set of trial velocities is determined by a linearly spaced function over the range of the set of trial velocities.

15. The system of claim 12, wherein the information handling system is configured to update the initial trial velocity with a new trial velocity.

16. The system of claim 12, wherein the shifting the group of traces is performed by a circular time shift.

17. The system of claim 16, wherein at least part of a shifted trace from the shifted group of traces is wrapped around itself.

18. The system of claim 16, wherein the circular time shift may be performed by a fast Fourier transform or discrete Fourier transform.

19. The system of claim 12, wherein the coherence value is computed by semblance, normalized energy, or zero lag cross correlation value.

20. The system of claim 12, wherein the information handling system is configured to a table of the coherence values indexed by the trial velocity and the depth of the shifted group of traces.
